(19) United States
(12) Patent Application Publication
(10) Pub. No.: US 2009/0200224 A1
(43) Pub. Date: Aug. 13, 2009

(54) COMBINATION FILTER FOR DIESEL FUEL

(75) Inventor: Giorgio Girondi, Mantova (IT)

Correspondence Address: BROWDY AND NEIMARK, P.L.L.C.;624 NINTH STREET, NW, SUITE 300, WASHINGTON, DC, 20001-5303, US

(73) Assignee: UFI FILTERS S.P.A., Mantova (IT)

(21) Appl. No.: 11/996,664

(22) PCT Filed: Jul. 18, 2006
(86) PCT No.: PCT/EP06/07082

§ 371 Date: Jul. 23, 2008

(30) Foreign Application Priority Data
Jul. 29, 2005 (IT) RE2005A000095

(51) Int. Cl. B01D 29/50

(52) U.S. Cl. 210/315

(57) ABSTRACT

A combination filter (1) for diesel fuel, comprising an outer casing (2), a filter cartridge (5) dividing the interior of the casing (2) into two separate chambers (6, 7) to which an inlet conduit (3) for the diesel fuel to be filtered and an outlet conduit (4) for the filtered diesel oil are connected respectively, said cartridge (5) having a filtering capacity for the diesel fuel which is at least equal to that required by the specific application, said cartridge (5) comprising at least two filtering baffles (50, 51) associated with each other in such a manner as to be traversed in series by the diesel fuel to be filtered, that filtering baffle (50) more upstream with respect to the direction in which the diesel fuel traverses having a filtering capacity less than that required by the specific application but such as to retain the solid phase component of the diesel fuel which forms at the paraffin formation temperature.

### TECHNICAL FIELD

The present invention relates to a combination filter for diesel fuel. More particularly, the present invention relates to a combination filter for diesel fuel able to operate effectively at temperatures less than the paraffin precipitation temperature of the diesel fuel.

### PRIOR ART

Diesel fuel filters are known to consist of an outer casing containing a filter cartridge which divides the interior into separate chambers connected respectively to an inlet conduit for the diesel fuel to be filtered and to an outlet conduit for the filtered diesel fuel. The outer casing generally consists of a cup-shaped hollow body and a cover which closes it, while the filter cartridge comprises a tubular filtering medium or baffle supported between a lower base and a stem fixed to the cover.

The performance of a filter is known to depend on its filtering capacity, i.e. the quantity of impurities which it is able to retain. This filtering capacity must satisfy the specific requirements of the application. It is therefore not possible to use filters having a filtering capacity less than that required.

Filter cartridges are also known formed from two baffles positioned in series; an example of a filter cartridge comprising two baffles is illustrated in document GB 826114. Specifically, the document describes a filter cartridge comprising two series-positioned baffles of which one is cylindrical and performs pre-filtration, and one is of star geometry and performs fine filtration of the impurities contained in the fuel.

At the particularly low temperatures generally present during the winter season, diesel fuel fed motor vehicles usually experience considerable ignition difficulties. This is due to the formation of solidified paraffins within the filter, which hence suddenly clogs, preventing the diesel fuel pumped by the pump from regularly passing through the filtering baffle. Typically, paraffins form when the diesel fuel reaches a temperature lower than the so-called paraffin precipitation temperature.

To enable vehicles to start correctly, it is widespread practice to install an electrical resistance heater within the filter, to operate when the diesel fuel temperature reaches a value less than the paraffin formation temperature.

This heater melts the solid paraffins, to enable them to pass through the filter without clogging.

Although these heaters usefully perform their paraffin melting function, their use presents certain problems and drawbacks.

In this respect, they have to be connected to a power source, usually the vehicle battery, consequently they require energy to operate, together with suitable cabling.

Essentially, the use of electric heaters involves a certain constructional complexity which increases the cost of the filters in which they are provided. There is therefore a strongly felt requirement for a diesel fuel filter able to effectively filter the diesel fuel even at temperatures substantially less than the paraffin precipitation temperature, without using any heater, within the framework of a constructionally simple and economical solution.

### DISCLOSURE OF THE INVENTION

The object of the present invention is to provide a combination filter for diesel fuel having structural and functional characteristics such as to satisfy said requirements while at the same time obviating the stated problems of the known art.

This object is attained by a combination filter for diesel fuel in accordance with claim 1.

The dependent claims define particularly advantageous preferred embodiments of the combination filter for diesel fuel according to the invention.

### BRIEF DESCRIPTION OF THE DRAWINGS

Further characteristics and advantages will be apparent on reading the ensuing description provided by way of non-limiting example, with the aid of the figures of the accompanying drawing, in which:

FIG. 1 is a longitudinal section through a filter in accordance with the present invention;

FIG. 2 is a section on the line II-II of FIG. 1.

FIG. 3 is a section through a second embodiment of the filter cartridge of the invention;

FIG. 4 is a section through a third embodiment of the filter cartridge of the invention.

### BEST MODE FOR CARRYING OUT THE INVENTION

With reference to said figures, the reference numeral 1 indicates overall a combination filter for diesel fuel in accordance with the present invention. The filter 1 comprises an outer casing 2 provided with an inlet conduit 3 for the diesel fuel to be filtered and an outlet conduit 4 for the filtered diesel fuel. In particular, the outer casing 2 is formed from a cup-shaped hollow body 20, which is seal closed by a cover 21, on which said inlet conduit 3 and outlet conduit 4 are provided.

The cover 21 is joined to the body 20 by usual fixing means, not shown for simplicity, such as welding, seam-joining or a threaded connection.

The outer casing 2 houses in its interior a filter cartridge 5 which, associated with the cover 21, divides the interior into two separate chambers 6 and 7, of which the first 6 communicates with the inlet conduit 3 for the diesel fuel to be filtered and the second 7 with the outlet conduit 4 for the filtered diesel fuel.

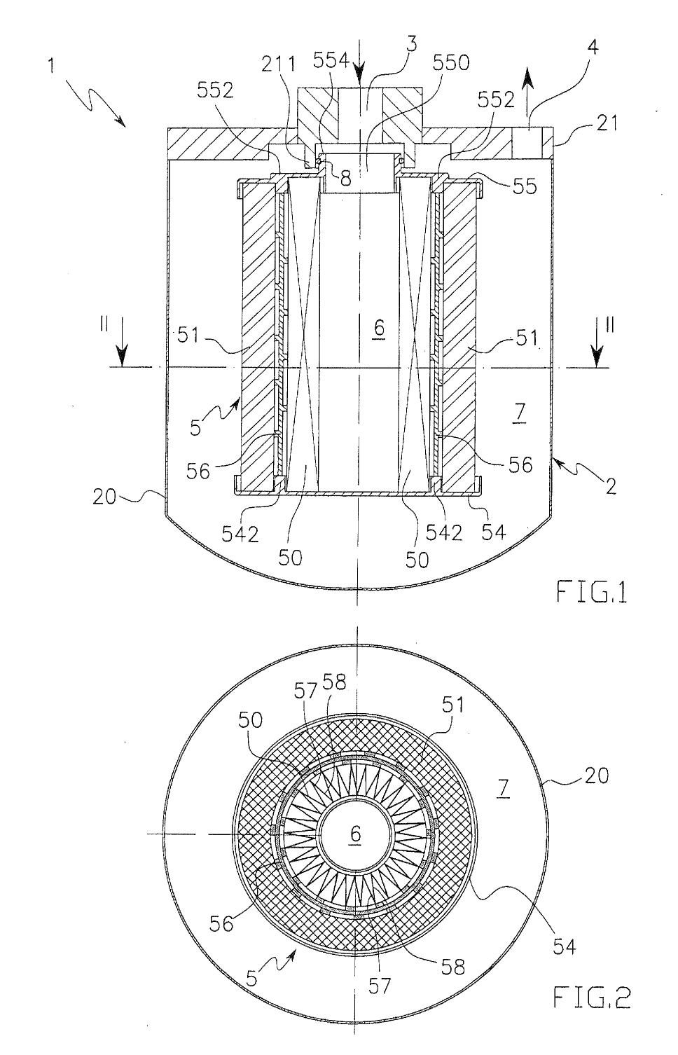

Specifically, the filter cartridge 5, in accordance with the first embodiment of the invention shown in FIGS. 1 and 2, comprises an inner tubular filtering baffle 50 and an outer filtering baffle 51, which is also tubular but of greater diameter and is positioned concentrically about the first.

Moreover, both the filtering baffles 50, 51, described hereinafter, are supported between a lower disc 54 and an upper disc 55, to which they are permanently joined together by usual fixing means, such as glues or welds. In detail, the lower disc 54 is closed, whereas the upper disc 55 is provided with a central hole 550 connecting the chamber 6 of the diesel fuel to be filtered to the inlet conduit 3.

Both the lower disc 54 and upper disc 55 are provided with circularly extending, mutually facing projecting ribs, 542 and 552 respectively (FIG. 1) which maintain the filtering baffles 50 and 51 separated and support a tubular perforated support 56 interposed between the two filtering baffles 50, 51, and of which the purpose is to enable diesel fuel to pass, while at the same time retaining both the filtering baffles 50, 51 to prevent their movement or deformation.

The filter cartridge 5 overall is joined to the cover 21 of the filter 1 by the upper disc 55, which comprises a projecting stem 554 engaging as an exact fit, by way of an interposed usual seal member 8 (O-ring) within a corresponding cylindrical seat provided in the cover 21 and defined by a circular rib 211 projecting from that surface facing the interior thereof.

In particular, the rib 211 surrounds the inlet conduit 3, so that on fitting the stem 554 into the rib 211 the interior of the filter 1 is divided into the two separate chambers 6 and 7, the hermetic separation of which is ensured by the seal means 8 and the closed lower disc 54.

According to the present invention, the degree of filtration effectively required is achieved by passage of the diesel fuel in series from the inner baffle 50 to the outer baffle 51.

The inner filtering baffle 50 has an undulated profile in cross-section, preferably of star geometry type (FIG. 2), and has a filtering capacity less than that effectively required by the application, but sufficient to block any solid phase paraffins which form at temperatures lower than the paraffin precipitation temperature. The undulated surface of the baffle defines preferential accumulation regions for the solid paraffin components in proximity to the base of each undulation. In the case of a filter of star geometry, the paraffin accumulation regions consist of the cusp region 57 into which the flanks of each pleat 58 of the baffle 50 converge.

The star geometry of the filter results in a filtering surface in contact with the diesel fuel to be filtered which is much greater, for equal diameter, than that of a cylindrical filter, with the result that the solid paraffin components employ a greater time to cover the star surface of the filter and to accumulate within the accumulation region 57 of each pleat. This enables the engine to also be started under very low temperature conditions without the danger of baffle clogging.

The outer filtering baffle 51, preferably a deep baffle surrounding the inner baffle 50 and formed preferably of synthetic material, is to effect actual filtering of the diesel fuel liquid phase which has passed through the inner baffle 50, and consequently presents a filtering capacity at least equal to that effectively required, i.e. between 5 and 10 μm.

In other words, the inner filtering baffle 50 carries out a coarse pre-filtration, in that it retains any solid phase component (paraffins) present in the diesel fuel, a frequent situation at low temperatures, while enabling the liquid component of the diesel fuel to pass and be finely filtered by the deep outer baffle 51, which must satisfy the specific requirements of the application. Preferably, the inner filtering baffle 50 presents pores of dimensions between 10 and 40 μm.

In use, the diesel fuel to be filtered is fed into the filter 1 by a usual pumping unit via the inlet conduit 3. By flowing through the central hole 55 of the upper disc 55, the diesel fuel fills the chamber 6 in the centre of the cartridge 5, and is urged by the pressure exerted by the pumping unit to pass through the filtering baffles 50 and 51 in series, to be filtered and then pass into the chamber 7. On reaching the chamber 7, the filtered part of the diesel fuel finally reaches the outlet conduit 4.

During filtration, any paraffins present in the diesel fuel are retained by the inner baffle 50, which enables only the diesel fuel liquid component to pass, to be then filtered in accordance with the required specification by the outer baffle 51. Because of the large surface of the inner baffle 50, said paraffins are able to deposit randomly on it, becoming accumulated preferably starting from the cusp region 57, without suddenly clogging it; in this manner, when the vehicle on which the filter is applied has started, the paraffins become subsequently dissolved by the hot recirculating diesel fuel, to in practice regenerate the inner baffle.

FIG. 3 shows a variant of the invention according to which the filter cartridge 5 comprises the outer cylindrical baffle 51 and an inner baffle 52 having in cross-section an undulated geometrical shape, in particular a petal shape.

Compared with the star shape of the baffle 50, the undulated geometrical surface of the baffle 52 ensures a greater contact surface with the diesel fuel to be filtered and a greater volume of the region at the base of each petal, in which the solid paraffin components accumulate. Consequently, if the engine is started under conditions in which the ambient temperature is less than the paraffin precipitation temperature, the solid paraffin components employ more time to cover the surface of the filtering baffle, enabling the engine to start. When the engine is moving, the hot recirculating diesel fuel dissolves the solid paraffin components.

As will be apparent from the description, the combination filter for diesel fuel of the present invention enables those requirements to be satisfied and overcomes those drawbacks of the known art specified in the introduction to the present description.

In this respect the filter of the present invention does not require the use of any diesel fuel heater. This is by virtue of the use of a pair of filtering baffles through which the diesel fuel passes in series, and of which the upstream baffle, i.e. the inner baffle in the described embodiment, which is traversed first, has the task of retaining only possible paraffins to prevent clogging of the downstream filter, which effects fine filtration.

Finally, a considerable saving is achieved with said filter, because the addition of the second baffle (the coarse baffle) represents a relatively low cost as economical cellulose or synthetic material baffles can be used, which do not have to satisfy a rigid specification in terms of efficiency and loading capacity.

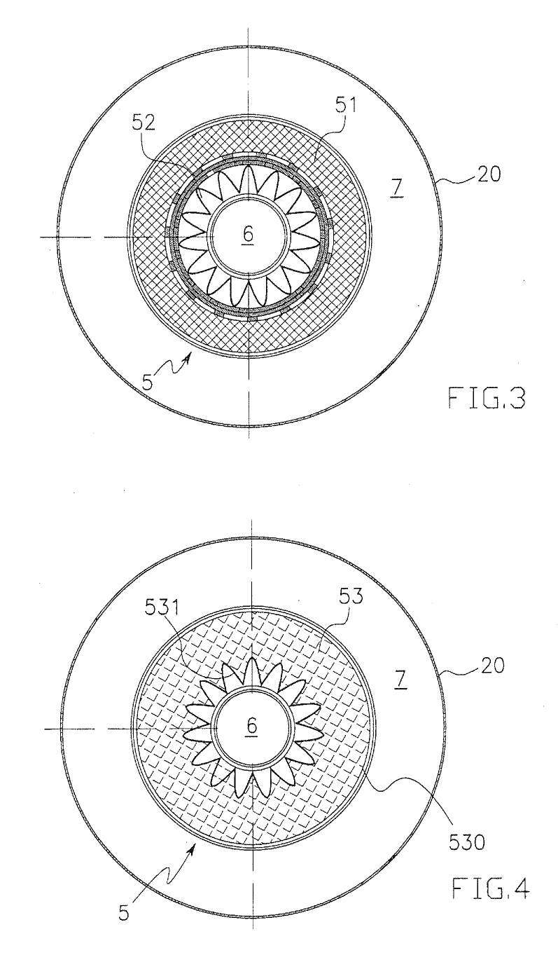

FIG. 4 shows a third embodiment of the invention, in which the two baffles 51 and 52 of the filter cartridge 5 shown in FIG. 3 are formed in one piece, i.e. monolithic, to form a filtering baffle 53 consisting of a single body having two portions, the inner portion forming the undulated inner surface 531 of the outer portion 530. The inner portion faces the inlet conduit for the diesel fuel to be filtered, while the outer portion faces the outlet conduit for the filtered diesel fuel.

With reference to FIG. 4, the outer surface 533 of the outer portion 530 is cylindrical, whereas the surface of the inner portion 531 is undulated for the same aforegoing reasons.

The filtering capacity of the baffle 53 is determined by the material of the outer portion 532, the porosity of which is between 5 and 10 μm, and is equal to the filtering capacity required by the application; in contrast the porosity of the inner surface 531 is between 10 and 40 μm, such as to filter out the solid paraffin components.

The illustrated embodiments all relate to a filter with a toroidal filter cartridge, in which filtration takes place from the inside towards the outside of the filter; however in other embodiments filtration can take place from the outside is towards the inside, and the filter cartridge can assume different configurations, for example it can comprise at least two baffles positioned in series, either spaced apart or mutually integral. An expert of the art can apply numerous modifications and variants to the aforedescribed combination filter for filtered diesel fuel in order to satisfy specific contingent requirements, all however contained within the scope of protection of the invention, as defined by the following claims.

1. A combination filter (1) for diesel fuel, comprising an outer casing (2), a filter cartridge (5) dividing the interior of the casing (2) into two separate chambers (6, 7) to which an inlet conduit (3) for the diesel fuel to be filtered and an outlet conduit (4) for the filtered diesel oil are connected respectively, characterised in that said cartridge (5) comprises at least two filtering baffles (50, 51, 52, 53, 531) associated with each other in such a manner as to be traversed in series by the diesel fuel to be filtered, that filtering baffle (50, 52, 531), more upstream with respect to the direction in which the diesel fuel traverses, with an undulated surface and having a filtering capacity less than that required by the specific application but such as to retain the solid phase component of the diesel fuel which forms at the paraffin formation temperature.

2. A filter (1) as claimed in claim 1, wherein said cartridge (5) comprises a pair of tubular filtering baffles (50, 51) associated with each other and positioned one inside the other, the more upstream said baffle (50) being the inner baffle.

3. A filter (1) as claimed in claim 2, wherein said chamber (6) to which the inlet conduit (3) for the diesel fuel to be filtered is connected is enclosed by said inner filtering baffle (50).

4. A filter (1) as claimed in claim 2, wherein said chamber (7) to which the outlet conduit (4) for the filtered diesel fuel is connected surrounds said cartridge (5).

5. A filter (1) as claimed in claim 2, comprising a tubular perforated support (56) interposed between said two filtering baffles (50, 51).

6. A filter (1) as claimed in claim 2, wherein said inner filtering baffle (50) is of star geometry type.

7. A filter (1) as claimed in claim 2, wherein said inner baffle (52) presents a cross-section of petal shape.

8. A filter (1) as claimed in claim 2, wherein said filtering baffle (50) more upstream with respect to the diesel fuel traversing direction presents pores having dimensions between 10 μm and 40 μm.

9. A filter (1) as claimed in claim 2, wherein said outer filtering baffle (51) is a deep baffle.

10. A filter (1) as claimed in claim 2, wherein said filtering baffles (50, 51) are rigidly supported between a first disc (54) and a second disc (55).

11. A filter (1) as claimed in claim 9, wherein the outer casing (2) comprises a hollow body (20) closed by a cover (21) into which said diesel fuel inlet conduit (3) and outlet conduit (4) open, the second disc (55) being associated with said cover (21) in such a manner as to define said two separate chambers (6, 7).

12. A filter (1) as claimed in claim 10, wherein said second disc (55) is associated with the cover (21) by way of interposed seal means (8).

13. A filter as claimed in claim 1, characterised in that said at least two baffles are formed in one piece having two portions, the portion facing the inlet conduit for the diesel fuel to be filtered being the undulated surface of the outer portion.

14. A filter as claimed in claim 1, characterised in that said undulated surface provides undulated portions the base of which forms an accumulation region for the solid paraffin components.
